(19) United States
(12) Patent Application Publication
(10) Pub. No.: US 2017/0075058 A1
(43) Pub. Date: Mar. 16, 2017

(54) LAMINATING A QUANTUM DOT ENHANCEMENT FILM TO A LIGHT GUIDE PLATE

(71) Applicant: Hewlett-Packrd Development Company, L.P., Houston, TX (US)

(72) Inventors: Kuan-Ting Wu, Taichung (TW); Hui Leng Lim, Sugar Land, TX (US); Wei Kuang Chu, Taipei (TW)

(21) Appl. No.: 15/310,662

(22) PCT Filed: May 30, 2014
(86) PCT No.: PCT/US2014/040170

§ 371 Date: Nov. 11, 2016

(51) Int. Cl. F21V 8/00; F21V 9/16

(52) U.S. Cl. CPC G02B 6/0053; G02B 6/0065; F21V 9/16

(57) ABSTRACT

Methods, apparatus, systems and articles of manufacture are disclosed for providing a display device with a quantum dot enhancement film (QDEF) laminated to a light guide plate. Examples involve a device with a QDEF laminated to a light guide plate and/or laminating a QDEF to a light guide plate of a device.

### BACKGROUND

In recent years, flat panel displays (e.g., light emitting diode (LED) displays, liquid crystal displays (LCD), etc.) have become the norm in households, businesses, etc. Not only do flat panel displays allow for relatively more efficient use of space due to their panel design, but they implement technology that allows for clearer picture over previous generations of television (e.g., projection televisions, cathode ray tube (CRT), etc.).

Quantum dots are nanoparticles of semiconductor inorganic materials (e.g., lead sulfide (PbS), cadmium selenide (CdSe), zinc sulfide (ZnS), etc.). In many instances a size of a quantum dot particle is 2 to 10 nanometers, or about 10 to 20 atoms. Quantum dots are some of the first nano-products to be available commercially and may be used for illumination purposes.

### BRIEF DESCRIPTION OF THE DRAWINGS

FIG. 1A is a layer diagram of an example display including a laminated quantum dot enhancement film.

FIG. 1B is a layer diagram of an example quantum dot enhancement film laminated to a light guide plate of the example display of FIG. 1A.

FIG. 1C is a layer diagram of an example quantum dot enhancement film that may be used to implement the quantum dot enhancement film of FIGS. 1A and/or 1B.

FIG. 2 is a block diagram of an example display manufacturing system including a quantum dot enhancement film laminator constructed in accordance with the teachings of this disclosure to manufacture the quantum dot enhancement film of FIGS. 1A, 1B, and/or 1C.

FIG. 3 is a block diagram of an example quantum dot enhancement film laminator that may implement the quantum dot enhancement film laminator of FIG. 2.

FIG. 4 is a flowchart representative of example machine readable instructions that may be executed to implement the quantum dot enhancement film laminator of FIGS. 2 and/or 3.

FIG. 5 is a flowchart representative of example machine readable instructions that may be executed to implement a portion of the machine readable instructions of FIG. 4 to retrieve instructions for laminating a quantum dot enhancement film to a light guide plate.

FIG. 6 is a flowchart representative of example machine readable instructions that may be executed to implement a portion of the machine readable instructions of FIG. 4 to laminate a quantum dot enhancement film to a light guide plate.

FIG. 7 is a block diagram of a processor platform capable of executing the instructions of FIGS. 4, 5 and/or 6 to implement the quantum dot enhancement film laminator of FIGS. 2 and/or 3 to manufacture the quantum dot enhancement film FIGS. 1A, 1B, and/or 1C.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with at least one intermediate part located therebetween. Stating that any part is in contact with another part means that there is no intermediate part between the two parts.

### DETAILED DESCRIPTION

Examples disclosed herein involve laminating quantum dots and/or a quantum dot enhancement film (QDEF) on a light guide plate of a display device. Quantum dots display bright colors under influence of incident light due to fluorescence. Various hues are available based on the quantum dot material, the quantum dot size, and/or the incident light applied to the quantum dots. As disclosed herein, laminating a QDEF onto a light guide plate of a display device (e.g., a light emitting diode (LED) display, a liquid crystal display (LCD), etc.) may achieve a high color gamut, provide high brightness, be less thick, include less assembly, improve yield rate, and/or provide energy savings relative to previous techniques used in display devices.

As used herein, the term “laminate” (or any form thereof) is defined as applying to a surface, for example, by bonding (e.g., via a chemical bond), by adhering (e.g., via an adhesive), etc. Furthermore, “laminated on,” “laminated to,” “laminated with,” etc. may be used herein interchangeably.

An example display disclosed herein includes a light guide plate and a QDEF laminated on the light guide plate. In some examples, the QDEF is less than 0.3 millimeters thick when laminated to the light guide plate. Examples disclosed herein involve laminating a QDEF to a light guide plate of a display to improve a quality of the display. Some examples disclosed herein involve laminating a QDEF to a light guide plate of a display by bonding quantum dots to the light guide plate.

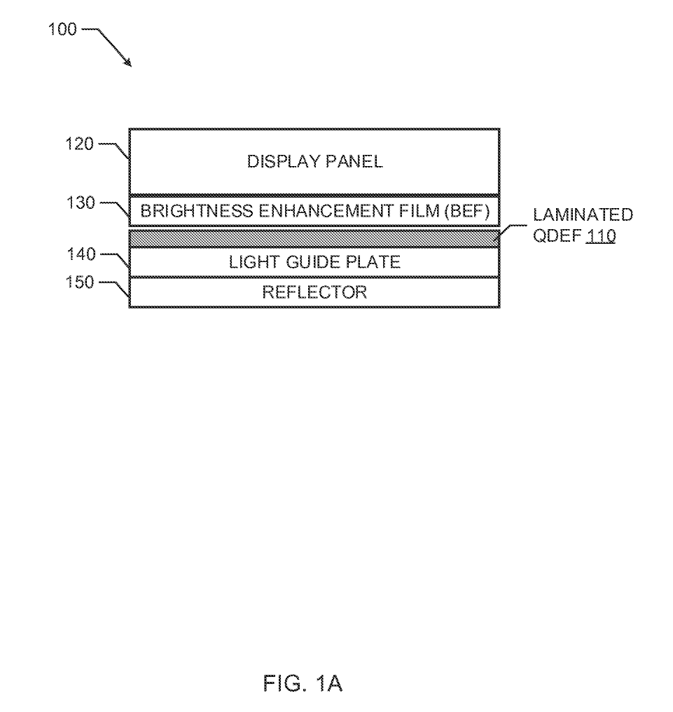

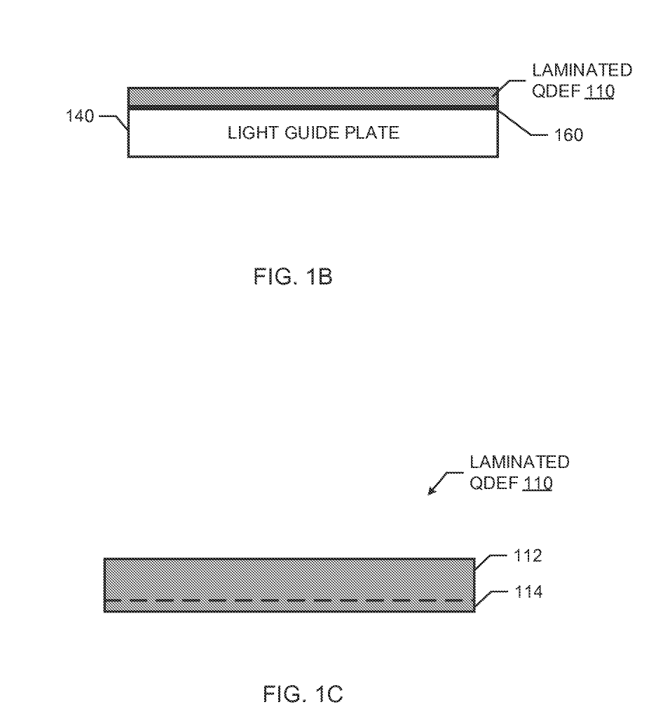

FIG. 1A is a layer diagram of an example display 100 including a laminated quantum dot enhancement film (QDEF) 110 constructed in accordance with the teachings of this disclosure. In the illustrated example of FIG. 1A, the display 100 includes the QDEF 110, a display panel 120, a brightness enhancement film 130, a light guide plate 140, and a reflector 150. The example display 100 may be a liquid crystal display (LCD), a light emitting diode (LED) display, an organic LED (OLED) display, a touchscreen display, etc.

The example display panel 120 of FIG. 1A may be glass, plastic, or any other type of material through which a user may view displayed images, video, text, etc. on the display 100. The brightness enhancement film 120 of FIG. 1A may be any suitable material and/or structure (e.g., prismatic) that increases brightness of the display 100 (e.g., a prism film). In some examples, multiple layers of the brightness enhancement film 130 or other types of brightness enhancement film may be included in the display 100. The example light guide plate 140 of FIG. 1A may be implemented by any suitable material (e.g., a resin, a plastic, etc.) including any type of suitable light guide pattern (e.g., V-cutting, dot printing, particulates, laser engraving, etc.) to provide a transparent and/or reflective panel of the display 100. The reflector 150 of the display 100 may be implemented by any suitable material (e.g., aluminum foil) having reflective properties to reflect light for the display 100.

The example QDEF 110 is laminated to the light guide plate 140 such that there is a relatively minimal air gap (or no air gap) between the light guide plate 140 and the QDEF 110. As illustrated in FIG. 1B, the QDEF 110 is laminated to the light guide plate 140 as illustrated by the adjoining laminate 160. The adjoining laminate 160 of the illustrated example of FIG. 1B represents an example laminate bond and/or joint between the QDEF 110 and the light guide plate 140. In the illustrated example of FIGS. 1A and 18, when the QDEF 110 is laminated to the light guide plate 140 air particles between the QDEF 110 and the light guide plate 140 are removed. Accordingly, there is little air gap or no air gap between the QDEF 110 and the light guide plate 140. Furthermore, the laminated QDEF 110 may partially or entirely mitigate light loss from the light guide plate 140 by limiting the air gap in between the light guide plate 140 and the QDEF 110.

In some examples, a thickness of the QDEF 110 may be limited to a designated thickness (e.g., less than 0.3 millimeters (mm)) to limit an overall thickness of the display 100 and/or a module of the display 100 (e.g., a housing of the display 100) of FIG. 1A. Furthermore, the directly bonded QDEF 110 allows for improved assembly of the display 100 as it avoids a step of aligning a separated QDEF with the light guide plate 140, brightness enhancement film 130, and/or other components of the display 100. In some examples, for touchscreen displays, a direct bonding of the QDEF 110 to the light guide plate 140 may improve bonding between a touch sensor of the display 100 and a LCD panel of the display 100.

In some examples, as illustrated in FIG. 1C, the QDEF 110 includes a quantum dot layer 112 and a barrier film layer 114. In such examples, the barrier film 114 is laminated to the light guide plate 140 and the quantum dot layer 112 is laminated to the barrier film layer. The example barrier film 114 may be implemented by any material and/or technique to form a suitable barrier to water vapor and/or oxygen between the light guide plate 140 and the quantum dot film 112.

The QDEF 110 may include any combination of quantum dots, including, but not limited to, cadmium selenide (CdSe) and zinc selenide (ZnSe) combination, a cadmium sulfide (CdS) and mercury sulfide (HgS) combination, a cadmium sulfide (CdS) and zinc sulfide (ZnS) combination, a cadmium selenide (CdSe) and cadmium sulfide (CdS) combination, a cadmium selenide (CdSe) and zinc sulfide (ZnS) combination, a cadmium selenide (CdSe) and cadmium sulfide (CdS) and zinc sulfide (ZnS) combination, a cadmium selenide (CdSe) and zinc sulfide (ZnS) and cadmium sulfide (CdS) combination, a zinc selenide (ZnSe) and zinc sulfide (ZnS) combination, or a zinc copper indium sulfide (ZnCuInS₂) and other cadmium-free species combination.

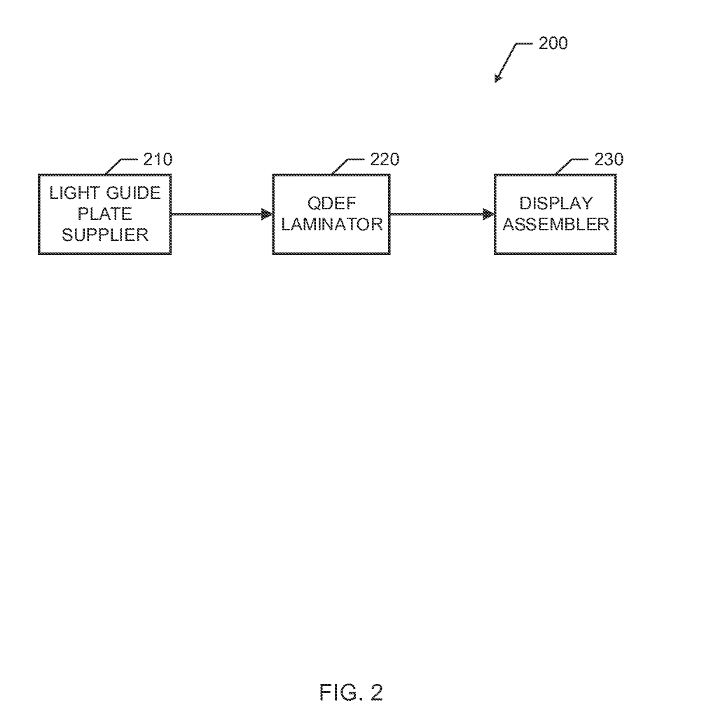

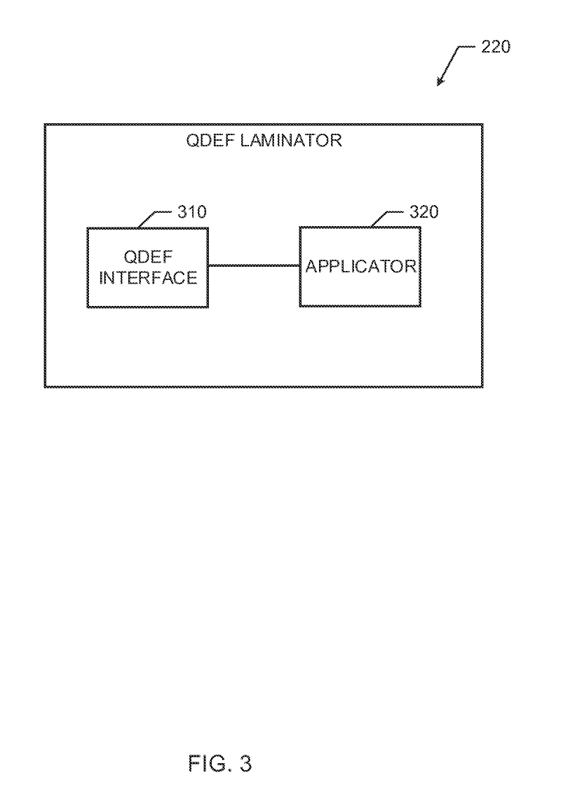

FIG. 2 is a block diagram of an example display manufacturing system 200 that facilitates assembly of display devices (e.g., the display 100 of FIG. 1A), including a QDEF laminator 220 constructed in accordance with the teachings of this disclosure. The example display manufacturing system includes a light guide plate supplier 210, the QDEF laminator 220, and a display assembler 230. The example light guide plate supplier 210 is a machine or device that receives, stores, and/or supplies light guide plates. For example, the light guide plate supplier 210 may be a storage rack, a conveyor belt, and/or a robot that facilitates and/or handles light guide plates that are to be inserted into display modules and/or housings. The light guide plate supplier 210 in the illustrated example of FIG. 2 provides light guide plates to the QDEF laminator 220. The QDEF laminator, which is described in further detail below in connection with FIG. 3, laminates a QDEF onto light guide plates and provides the QDEF laminated light guide plates to the display assembler 230. The example display assembler 230 of FIG. 2 inserts the QDEF laminated light guide plate into a display device (e.g., a housing of a display device). The display assembler 230 may also receive other components (e.g., display panels, reflectors, brightness enhancement films, etc.) from other component suppliers (not shown) of the display manufacturing system 200 that are to be used in assembly of a display device. The display assembler 230 may be implemented by any suitable assembly and/or manufacturing machine (e.g., a programmable robot).

Accordingly, the display manufacturing system 200 of FIG. 2 facilitates assembly of displays including a QDEF laminated to light guide plates of the assembled displays. The display manufacturing system 200 may provide an increased production yield rate when compared to previous techniques as the QDEF laminator 220 laminates the QDEF directly to a light guide plate, and thus provides for less moving parts (i.e., a QDEF laminated light guide plate versus a QDEF separate from a light guide plate) when the display assembler 230 assembles the displays. Furthermore, examples disclosed herein avoid an assembly challenge in quality arid productivity to prevent a QDEF from separating from a light guide plate, which may occur more frequently as non-laminated QDEFs become thinner within displays.

FIG. 3 is a block diagram of an example QDEF laminator 220, which may be used to implement the QDEF laminator 220 of FIG. 2. The example QDEF laminator 220 may be a device and/or apparatus in an assembly line for making displays and/or light guide plates. The QDEF laminator 220 of FIG. 3 includes a QDEF interface 310 and an applicator 320. The QDEF interface 310 and the applicator 320 may be communicatively coupled by wired and/or wireless communication links.

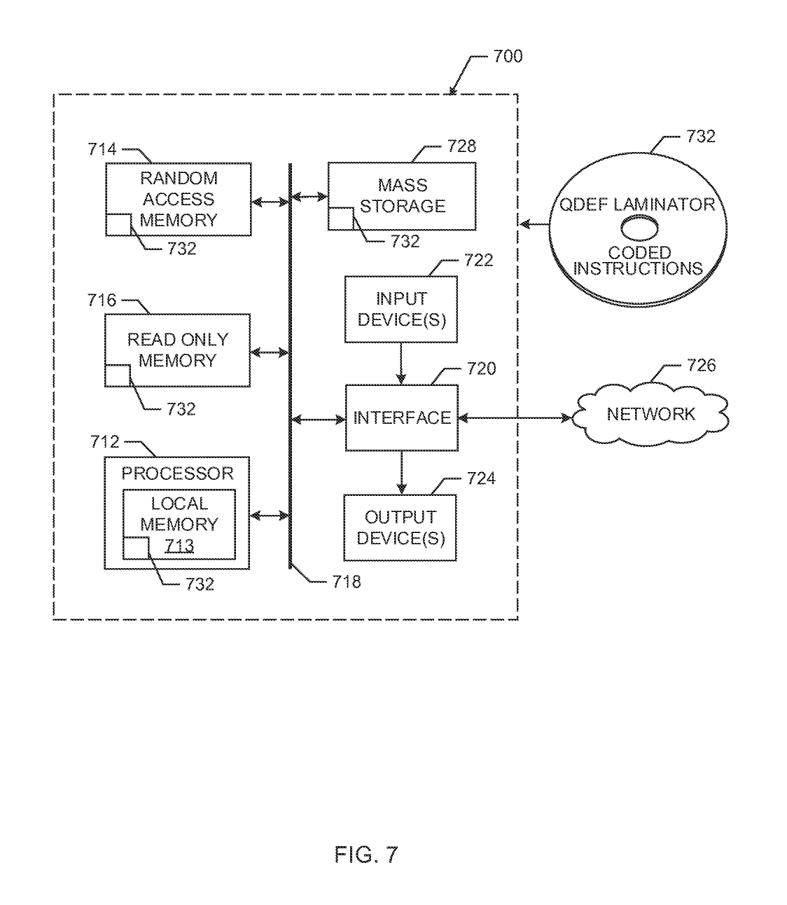

The QDEF interface 310 of the illustrated example of FIG. 3 allows a user to configure the QDEF laminator 220. For example the QDEF interface 310 may be comprised of input and/or output devices. The QDEF interface 310 may be implemented by the interface 720, input device(s) 722, and/or output device(s) 724 of FIG. 7, described below. In some examples, the QDEF laminator 220 may include a memory and/or database to store settings and/or information for laminating a QDEF (e.g., the QDEF 110) to a light guide plate (e.g., the light guide plate 140). For example, a memory and/or database may store instructions for types of quantum dots (e.g., cadmium sulfide, cadmium selenide, zinc selenide, etc.), thicknesses of QDEF layers, etc. Accordingly, in some examples, a user may indicate via the QDEF interface 310 a type, size, etc. of light guide plate that is to be laminated by the QDEF laminator 220, and the QDEF laminator 220 may determine a corresponding quantum dot configuration and/or barrier film configuration for laminating a corresponding QDEF on the light guide plate. In some examples, the QDEF laminator 220 may be configured to automatically detect and/or determine a type of light guide plate that is to be laminated with a QDEF. In such examples, the QDEF laminator 220 may be universally used to laminate various types and/or sizes of light guide plates.

The applicator 320 of the example QDEF laminator 220 illustrated in FIG. 3 applies a QDEF (e.g., the QDEF 110 of FIG. 1A) to a light guide plate (e.g., the light guide plate 140). The example applicator 320 may bond, adhere, etc., quantum dots and/or a barrier film to the light guide plate in accordance with instructions received from the QDEF interface 310 and/or instructions stored in a database associated with the QDEF laminator 220. In some examples, the applicator 320 applies a barrier film to the light guide plate and applies quantum dots to the barrier film. In some examples, the applicator 320 forms a QDEF including both a barrier film and a quantum dot configuration before directly bonding the QDEF to a light guide plate. In some examples, the applicator 320 receives quantum dots from a supply of quantum dots. In other examples, the applicator 320 may form quantum dots (e.g., from quantum dot nanoparticles, such as atoms of cadmium, sulfur, zinc, mercury, etc.) and/or quantum dot configurations (from formed quantum dots) prior to forming a QDEF and/or applying the QDEF.

While an example manner of implementing the QDEF laminator 220 of FIG. 2 is illustrated in FIG. 3, at least one of the elements, processes and/or devices illustrated in FIG. 3 may be combined, divided, re-arranged, omitted, eliminated and/or implemented in any other way. Further, QDEF interface 310, the applicator 320, and/or, more generally, the example QDEF laminator 220 of FIG. 3 may be implemented by hardware, software, firmware and/or any combination of hardware, software and/or firmware. Thus, for example, any of QDEF interface 310, the applicator 320, and/or, more generally, the example QDEF laminator 220 of FIG. 3 could be implemented by at least one of an analog or digital circuit, a logic circuit, a programmable processor, an application specific integrated circuit (ASIC), a programmable logic device (PLD) and/or a field programmable logic device (FPLD). When reading any of the apparatus or system claims of this patent to cover a purely software and/or firmware implementation, at least one of the QDEF interface 310 or/and the applicator 320 is/are hereby expressly defined to include a tangible computer readable storage device or storage disk such as a memory, a digital versatile disk (DVD), a compact disk (CD), a Blu-ray disk, etc. storing the software and/or firmware. Further still, the example QDEF laminator 220 of FIG. 3 may include at least one element, process, and/or device in addition to, or instead of, those illustrated in FIG. 3, and/or may include more than one of any or all of the illustrated elements, processes and devices.

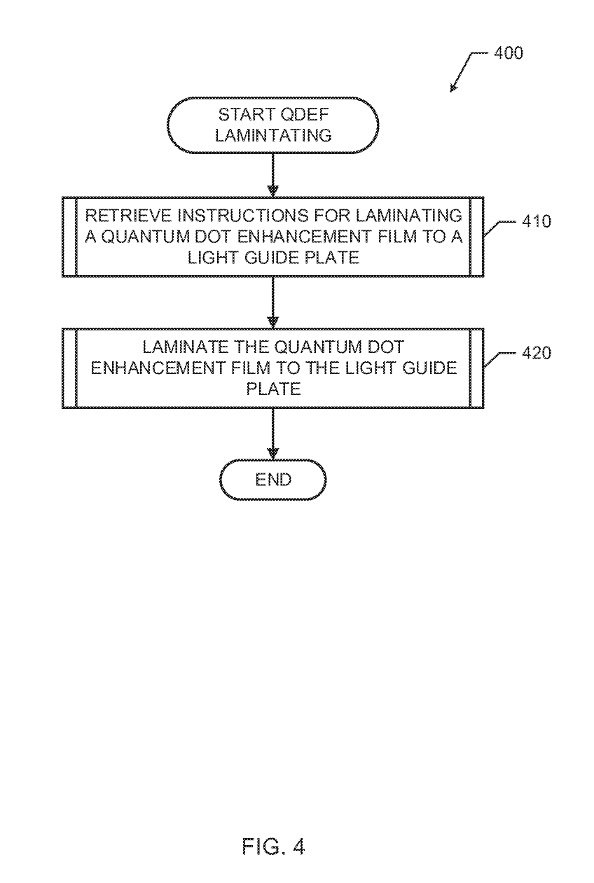

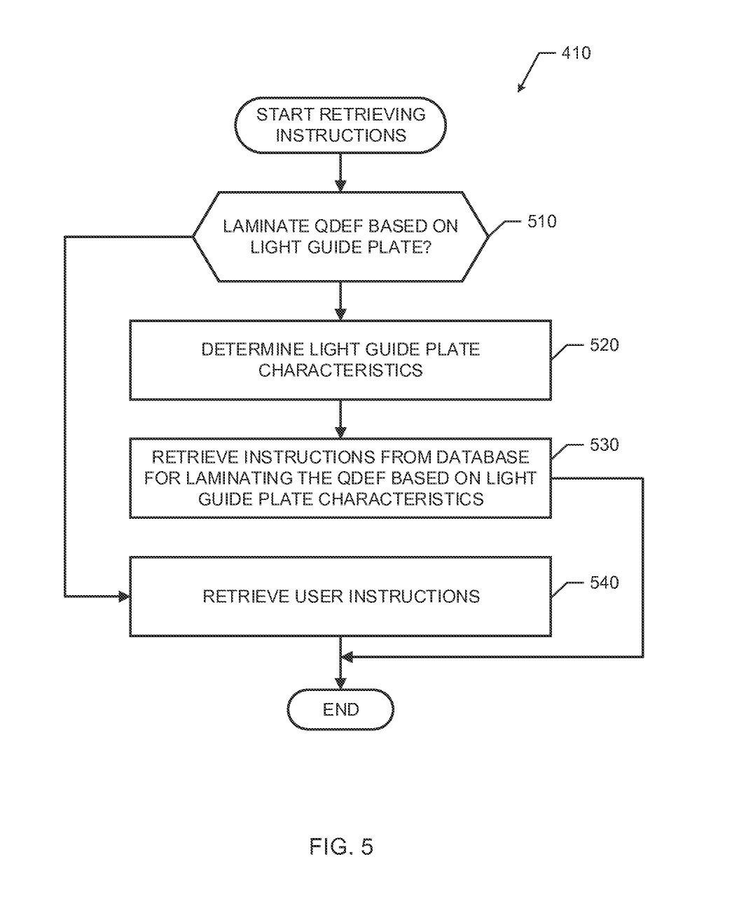

Flowcharts representative of example machine readable instructions for implementing the QDEF laminator 220 of FIGS. 2 and/or 3 are shown in FIGS. 4, 5 and/or 6. In this example, the machine readable instructions comprise a program/process for execution by a processor such as the processor 712 shown in the example processor platform 700 discussed below in connection with FIG. 7. The programs/processes may be embodied in software stored on a tangible computer readable storage medium such as a CD-ROM, a floppy disk, a hard drive, a digital versatile disk (DVD), a Blu-ray disk or a memory associated with the processor 712, but the entire programs/processes and/or parts thereof could alternatively be executed by a device other than the processor 712 and/or embodied in firmware or dedicated hardware. Further, although the example programs/processes are described with reference to the flowcharts illustrated in FIGS. 4, 5, and/or 6, many other methods of implementing the example QDEF laminator 220 may alternatively be used. For example, the order of execution of the blocks may be changed, and/or some of the blocks described may be changed, eliminated, or combined.

The process 400 is executed to implement the QDEF laminator 220 to laminate a QDEF to a light guide plate that is to be installed in a display (e.g., a LCD). The process 400 may be iterative. Accordingly, the QDEF laminator 220 may repeat the process 400 for each light guide plate that is to be laminated. In some examples, the QDEF laminator 220 may monitor for receipt of a light guide plate from the light guide plate supplier 210. Upon receipt of the light guide plate, the QDEF laminator 220 may be implemented by the process 400 of FIG. 4.

The example process 400 of FIG. 4 begins at block 410 (e.g., in response to startup of the display manufacturing system 200, installation of the QDEF laminator 220, etc.). At block 410, the QDEF interface 310 of the QDEF laminator 220 retrieves and/or receives instructions for laminating a quantum dot enhancement film to a light guide plate. At block 420, the applicator of the QDEF laminator 220 laminates the quantum dot enhancement film to the light guide plate. After block 420, the process 400 ends.

FIG. 5 illustrates an example process 410, representative of machine readable instructions that may be executed to implement block 410 of FIG. 4 and/or to implement QDEF interface 310 of FIG. 3 to retrieve instructions for laminating a QDEF to a light guide plate. Such instructions may include an indication that the QDEF is to include certain characteristics, for example, a type of quantum dot configuration, material, thickness, a presence of a barrier film, or any other characteristic of the QDEF. The process 410 begins at block 510 with an initiation of the QDEF laminator 220. At block 510, the QDEF interface 310 determines whether the QDEF laminator 220 is to laminate a QDEF based on a light guide plate received from the light guide plate supplier 210. In other words, the QDEF interface 310 determines whether the characteristics of the received light guide plate are to be determined and/or analyzed for laminating the QDEF. If the QDEF interface 310 determines that the QDEF is not to be laminated based on the characteristics of the light guide plate, control advances to block 540. If the QDEF interface 310 determines that the QDEF is to be laminated based on the characteristics of the light guide plate (block 510), the QDEF interface 310 determines characteristics of the light guide plate received form the light guide plate supplier 210. For example, the QDEF laminator 220 may use sensors to scan and/or analyze the received light guide plate to identify characteristics of the light guide plate (e.g., transmittance, configuration, size, materials, etc.). At block 530, the QDEF interface retrieves instructions from a database (e.g., a database of the QDEF laminator 220 and/or a database in communication with the QDEF laminator 220) for laminating the QDEF based on the light guide plate characteristics.

At block 540, the QDEF interface 310 retrieves user instructions for laminating the QDEF to the light guide plate. In some examples, the QDEF interface may retrieve default instructions and/or most recently received instructions from a user for laminating a QDEF to a light guide plate. Additionally or alternatively, the QDEF interface 310 may prompt a user for instructions for laminating the QDEF to the light guide plate. After block 530 or 540 in the illustrated example of FIG. 5, the process 410 ends.

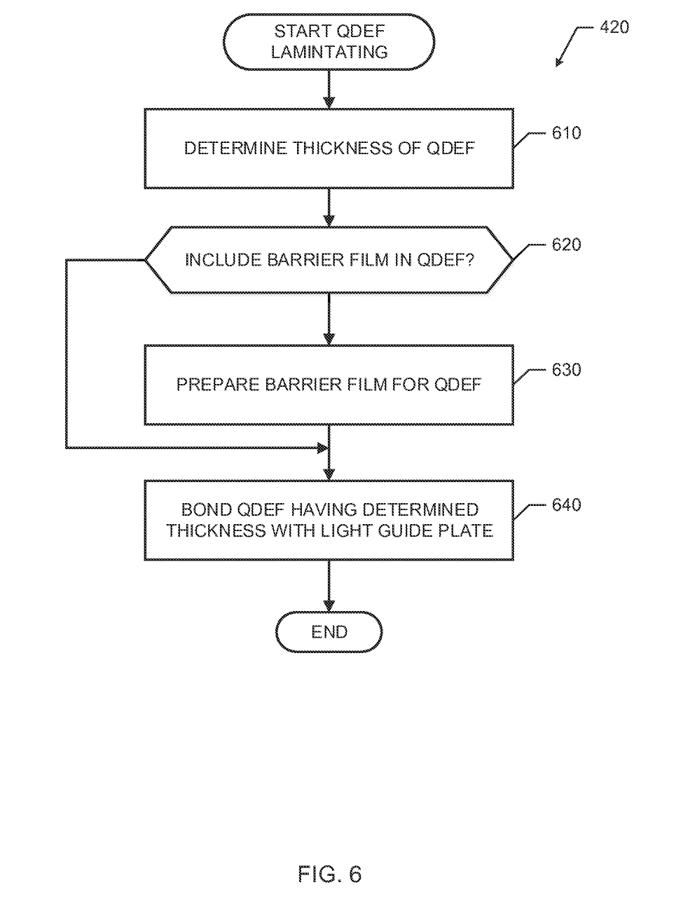

FIG. 6 illustrates an example process 420, representative of machine readable instructions that may be executed to implement block 420 of FIG. 4 and/or to implement the applicator 320 of FIG. 3 to laminate a QDEF to a light guide plate. At block 610 of FIG. 6, the applicator 320 may determine a desired thickness of the QDEF that is to be laminated to a light guide plate. For example, the applicator 320 may refer to instructions received from the QDEF interface 310 that indicate the thickness. At block 620, the applicator 320 determines whether to include a barrier film in the QDEF (e.g., by referring to the instructions received from the QDEF interface 310). If, at block 620, the applicator 320 determines that a barrier film is not to be included in the QDEF, control advances to block 640. If the applicator 320 determines that a barrier film is to be included in the QDEF (block 620), at block 630, the applicator 320 prepares a barrier film for the QDEF. For example, at block 630, the applicator 320 may form a barrier film for the QDEF and/or apply a barrier film to the light guide plate (e.g., using chemical bonding, an adhesive, etc.).

At block 640, the applicator 320 bonds the QDEF having the determined thickness with the light guide plate. For example, at block 640, the applicator 320 may bond the QDEF (with our without the barrier film) directly to the light guide plate. After block 640, the example process 420 ends.

As mentioned above, the example processes of FIGS. 4, 5 and/or 6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally. or alternatively, the example processes of FIGS. 4, 5, and/or 6 may be implemented using coded instructions (e.g., computer and/or machine readable instructions) stored on a non-transitory, computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 7 is a block diagram of an example processor platform 700 capable of executing the instructions of FIGS. 4, 5 and/or 6 to implement the QDEF laminator 220 of FIGS. 2 and/or 3. The processor platform 700 can be, for example, a server, a personal computer, a mobile device (e.g., a cell phone, a smart phone, a tablet such as an iPad™ , etc.), a personal digital assistant (PDA), an Internet appliance, a field device, a control system device, or any other type of computing device.

The processor platform 700 of the illustrated example of FIG. 7 includes a processor 712. The processor 712 of the illustrated example is hardware. For example, the processor 712 can be implemented by at least one integrated circuit, logic circuit, microprocessor or controller from any desired family or manufacturer.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), God/Ora PCI express interface.

In the illustrated example, at least one input device 722 is connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touchscreen, a track-pad, a trackball, ISO-point and/or a voice recognition system.

At least one output device 724 is also connected to the interface circuit 720 of the illustrated example. The output device(s) 724 can be implemented, for example, by display devices (e.g., a light emitting diode (LED), an organic light emitting diode (OLED), a liquid crystal display, a cathode ray tube display (CRT), touchscreen, a tactile output device, a printer and/or speakers). The interface circuit 720 of the illustrated example, thus, typically includes a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The processor platform 700 of the illustrated example also includes at least one mass storage device 728 for storing software and/or data. Examples of such mass storage device(s) 728 include floppy disk drives, hard drive disks, compact disk drives, Blu-ray disk drives, RAID systems, and digital versatile disk (DVD) drives.

The coded instructions 732 of FIGS. 4, 5, and/or 6 may be stored in the mass storage device 728, in the local memory 713 in the volatile memory 714, in the non-volatile memory 716, and/or on a removable tangible computer readable storage medium such as a CD or DVD.

From the foregoing, it will be appreciated that the above disclosed methods, apparatus and articles of manufacture involve a QDEF laminated to a light guide plate of a display device. The examples disclosed herein for providing a laminated QDEF on a light guide plate of a display device may allow for the display device and/or manufacturing of the display to provide increased color gamut, brightness improvement, increased energy saving, reduction of display module thickness, improved assembly and production yield rate, and mitigation of light loss over previous techniques used in display devices.

Although certain example methods, apparatus and articles of manufacture have been disclosed herein, the scope of coverage of this patent is riot limited thereto. On the contrary, this patent covers all methods, apparatus and articles of manufacture fairly falling within the scope of the claims of this patent.

What is claimed is:

1. A display comprising:
a light guide plate; and
a quantum dot enhancement film laminated on the light guide plate.

2. The display of claim 1, wherein the quantum dot enhancement film comprises a quantum dot film and a barrier film, the barrier film being located between the light guide plate and the quantum dot film.

3. The display of claim 1, wherein the quantum dot enhancement film is laminated to the light guide plate by quantum dot direct bonding to remove air particles between the light guide plate and the quantum dot enhancement film.

4. The display of claim 1, wherein a thickness of the quantum dot enhancement film is less than 0.3 millimeters.

5. The display of claim 1, wherein the laminated quantum dot enhancement film relatively increases a color gamut of the display compared to a quantum dot enhancement film that is not laminated to the light guide plate.

6. The display of claim 5, wherein the display is a liquid crystal display.

7. The display of claim 1, wherein the laminated quantum dot enhancement film is to limit light loss from the light guide plate.

8. A method comprising:
retrieving instructions for laminating a quantum dot enhancement film to a light guide plate; and
laminating the quantum dot enhancement film to the light guide plate based on the instructions.

9. The method of claim 8, wherein laminating the quantum dot enhancement film comprises:
laminating a barrier film to the light guide plate; and
bonding quantum dots to the barrier film.

10. The method of claim 8, wherein the instructions indicate the quantum dot enhancement film is to have a thickness of less than 0.3 millimeters.

11. The method of claim 8, wherein laminating the quantum dot enhancement film to the light guide plate comprises a direct bonding of quantum dots with the light guide plate.

12. The method of claim 11, wherein the instructions indicate the quantum dots are to comprise at least one of a cadmium selenide and zinc selenide combination, a cadmium sulfide and mercury sulfide combination, a cadmium sulfide and zinc sulfide combination, a cadmium selenide and cadmium sulfide combination, a cadmium selenide and zinc sulfide combination, a cadmium selenide and cadmium sulfide and zinc sulfide combination, a cadmium selenide and zinc sulfide and cadmium sulfide combination, a zinc selenide and zinc sulfide combination, or a zinc copper indium sulfide (ZnCuInS₂) and other cadmium-free species combination.

13. An apparatus comprising:
an interface to manage instructions for laminating a quantum dot enhancement film on a light guide plate; and
an applicator to laminate quantum dots of the quantum dot enhancement film on a light guide plate based on the instructions.

14. The apparatus of claim 13, wherein the applicator is to:
bond the quantum dots to the light guide plate based on instructions received from a user.

15. The apparatus of claim 14, wherein the interface is to:
determine characteristics of the light guide plate; and
retrieve the instructions corresponding the characteristics of the light guide plate from a database.
